(19) United States
(12) Patent Application Publication
(10) Pub. No.: US 2025/0385611 A1
(43) Pub. Date: Dec. 18, 2025

(54) RESONANT POWER CONVERSION CIRCUIT AND CONTROL METHOD THEREOF WITH HIGH-SIDE TRANSISTOR ACHIEVING ZERO-VOLTAGE SWITCHING DURING STARTUP

(71) Applicant: Richtek Technology Corporation, Zhubei City (TW)

(72) Inventors: Ta-Yung YANG, Taoyuan City (TW); Kuo-Chi LIU, Hsinchu City (TW); Fu-Ciao SYU, New Taipei City (TW); Hsin-Yi WU, Zhubei City (TW); Kun-Yu LIN, Zhubei City (TW); Tzu-Chen LIN, Zhubei City (TW)

(21) Appl. No.: 19/220,592

(22) Filed: May 28, 2025

Related U.S. Application Data
(60) Provisional application No. 63/658,940, filed on Jun. 12, 2024.

(30) Foreign Application Priority Data
Jan. 15, 2025 (TW) 114101599

(51) Int. Cl. H02M 3/335; H02M 3/00

(52) U.S. Cl. CPC H02M 3/3353; H02M 3/01

(57) ABSTRACT

A power conversion circuit includes a transformer, a resonant capacitor, a high-side transistor, a low-side transistor, and a control circuit. The transformer includes a primary coil and a secondary coil, and the primary coil is coupled between a switch node and a resonant node. The resonant capacitor is coupled between the resonant node and a ground. The high-side transistor provides an input voltage to the switch node based on a high-side driving signal. The low-side transistor couples the switch node to the ground based on a low-side driving signal. The control circuit generates the high-side driving signal and the low-side driving signal. When the power converting circuit starts up, the control circuit generates a precharge signal to precharge the resonant capacitor.

### CROSS REFERENCE TO RELATED APPLICATIONS

This application claims the benefit of U.S. Provisional Application No. 63/658,940, filed on Jun. 12, 2024, the entirety of which is incorporated by reference herein.

This application claims priority of Taiwan Patent Application No. 114101599, filed on Jan. 15, 2025, the entirety of which is incorporated by reference herein.

### BACKGROUND OF THE INVENTION

### Field of the Invention

The disclosure is generally related to a resonant power conversion circuit and a control method thereof, and more particularly it is related to a resonant power conversion circuit and a control method thereof with the high-side transistor achieving zero-voltage switching during startup.

### Description of the Related Art

With the continuous advancements being made in portable electronic devices, the development of power conversion circuits, like most power products, is trending in the direction of high efficiency, high power density, high reliability, and low cost. Since resonant power conversion circuits (which include LLC resonant power conversion circuits, flyback power conversion circuits, and others) are high-efficiency and high-power density power conversion circuits, the power conversion circuits used in portable electronic devices are gradually moving towards resonant power conversion circuits.

However, current resonant power conversion circuits still have many defects, so it is necessary to further optimize resonant power conversion circuits.

### BRIEF SUMMARY OF THE INVENTION

The present invention proposes a power conversion circuit and a control method thereof. When the power conversion circuit starts up, the voltage surge of the switch node is reduced by precharging the resonant capacitor during the startup process. After the startup process is complete, turning on the low-side transistor first and then turning on the high-side transistor helps the high-side transistor achieve zero-voltage switching, to further stabilize the voltage of the switch node, thereby reducing noise, improving the reliability of circuit elements, and improving the conversion efficiency of the power conversion circuit.

In an embodiment, a power conversion circuit is provided, which comprises a transformer, a resonant capacitor, a high-side transistor, a low-side transistor, and a control circuit. The transformer comprises a primary coil and a secondary coil. The primary coil is coupled between a switch node and a resonant node. The resonant capacitor is coupled between the resonant node and a ground. The high-side transistor provides an input voltage to the switch node based on a high-side driving signal. The low-side transistor couples the switch node to the ground based on a low-side driving signal. The control circuit generates the high-side driving signal and the low-side driving signal. When the power conversion circuit starts up, the control circuit generates a precharge signal to precharge the resonant capacitor.

According to an embodiment of the present invention, the control circuit further comprises a charging diode. The precharge signal precharges the resonant capacitor through the charge diode.

According to an embodiment of the present invention, the power conversion circuit is configured to convert the input voltage into an output voltage.

According to an embodiment of the present invention, the power conversion circuit further comprises a rectification circuit. The rectification circuit is configured to convert energy of the secondary coil to the output voltage.

According to an embodiment of the present invention, the control circuit generates a charging current from the input voltage. The control circuit uses the charging current to generate a supply voltage powering the control circuit. The control circuit uses the charging current to generate the precharge signal precharging the resonant capacitor.

According to an embodiment of the present invention, when the supply voltage exceeds a threshold voltage, the control circuit stops generating the precharge signal. When the precharge signal is not being generated, the control circuit generates the high-side driving signal and the low-side driving signal.

According to an embodiment of the present invention, when the precharge signal is not being generated, the control circuit turns on the low-side transistor first and then turns on the high-side transistor, helping the high-side transistor to achieve zero-voltage switching.

According to an embodiment of the present invention, the power conversion circuit further comprises a charging resistor. The charging resistor is coupled to the input voltage and generating a charging current. The control circuit comprises a startup circuit. The startup circuit is configured to generate the precharge signal.

According to an embodiment of the present invention, the startup circuit comprises a normally-on transistor, a startup transistor, a startup resistor, and a startup diode. The normally-on transistor receives the precharge current. The startup transistor comprises a gate terminal, a drain terminal, and a source terminal, where the drain terminal is coupled to the normally-on transistor, and the source terminal generates the precharge signal. The startup resistor is coupled between the gate terminal and the drain terminal. The startup diode comprises an anode and a cathode, wherein the anode is coupled to the source terminal, and the cathode generates a supply voltage. The control circuit is powered by the supply voltage.

According to an embodiment of the present invention, the startup circuit further comprises a comparator. The comparator compares the supply voltage with a threshold voltage to generate a comparison signal. The comparison signal is provided to the gate terminal. When the supply voltage exceeds the threshold, the comparator turns off the startup transistor to stop generating the charging current and the precharge signal.

According to an embodiment of the present invention, the transformer further comprises an auxiliary coil, a supply capacitor, and a supply diode. The auxiliary coil generates an auxiliary coil voltage. The supply capacitor is configured to maintain the supply voltage. The supply diode is configured to use the auxiliary coil voltage to unidirectionally charge the supply capacitor to generate the supply voltage, so as to prevent the supply voltage from affecting the operation of the transformer. When the startup transistor is turned off, the auxiliary coil generates the supply voltage to charge the control circuit.

According to an embodiment of the present invention, when the auxiliary coil generates the supply voltage, the startup diode is configured to isolate the supply voltage from the source terminal, so as to prevent the supply voltage from affecting the precharge signal.

According to an embodiment of the present invention, the power conversion circuit is a resonant flyback power conversion circuit.

In another embodiment, a control method for controlling a power conversion circuit is provided. The power conversion circuit comprises a resonant capacitor coupled between a resonant node and a ground, a transformer comprising a primary coil and a secondary coil, a high-side transistor providing an input voltage to a switch node, and a low-side transistor coupling the switch node to the ground. The primary coil is coupled between the switch node and the resonant node, wherein the control method comprises the following steps. The resonant capacitor is precharged when the input voltage is provided to the power conversion circuit. It is determined whether a voltage across the resonant capacitor exceeds a target voltage. The high-side transistor and the low-side transistor are driven when the voltage across the resonant capacitor exceeds the target voltage.

According to an embodiment of the present invention, the step of precharging the resonant capacitor when the input voltage is provided to the power conversion circuit further comprises the following steps. A charging current is generated from the input voltage. The resonant capacitor is precharged using the charging current. A supply voltage is generated using the charging current.

According to an embodiment of the present invention, the power conversion circuit further comprises a control circuit. The control circuit is configured to execute the control method. The control circuit is powered by the supply voltage.

According to an embodiment of the present invention, the step of determining whether the voltage across the resonant capacitor exceeds the target voltage further comprises the following steps. It is determined whether the supply voltage exceeds a threshold voltage. The precharge current is stopped being generated when the supply voltage exceeds the threshold voltage. The supply voltage is positively correlated with the voltage across the resonant capacitor.

According to an embodiment of the present invention, when stopping precharging the resonant capacitor, an auxiliary coil of the transformer is used to generate the supply voltage.

According to an embodiment of the present invention, the step of driving the high-side transistor and the low-side transistor when the voltage across the resonant capacitor exceeds the target voltage further comprises the following steps. The low-side transistor is turned on when a voltage across the resonant capacitor exceeds the target voltage. The high-side transistor is turned on after the low-side transistor is turned off.

According to an embodiment of the present invention, when the high-side transistor is turned on after the low-side transistor is turned off, a current flowing through the primary coil helps the high-side transistor to achieve zero-voltage switching, thereby improving conversion efficiency of the power conversion circuit and stability of a voltage of the switch node.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a power conversion circuit in accordance with an embodiment of the present invention;

FIG. 2 is a waveform diagram of a power conversion circuit in accordance with an embodiment of the present invention;

FIG. 3 is a block diagram of a power conversion circuit in accordance with another embodiment of the present invention;

FIG. 4 is a block diagram of a startup circuit in accordance with an embodiment of the present invention; and

FIG. 5 is a flow chart of a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

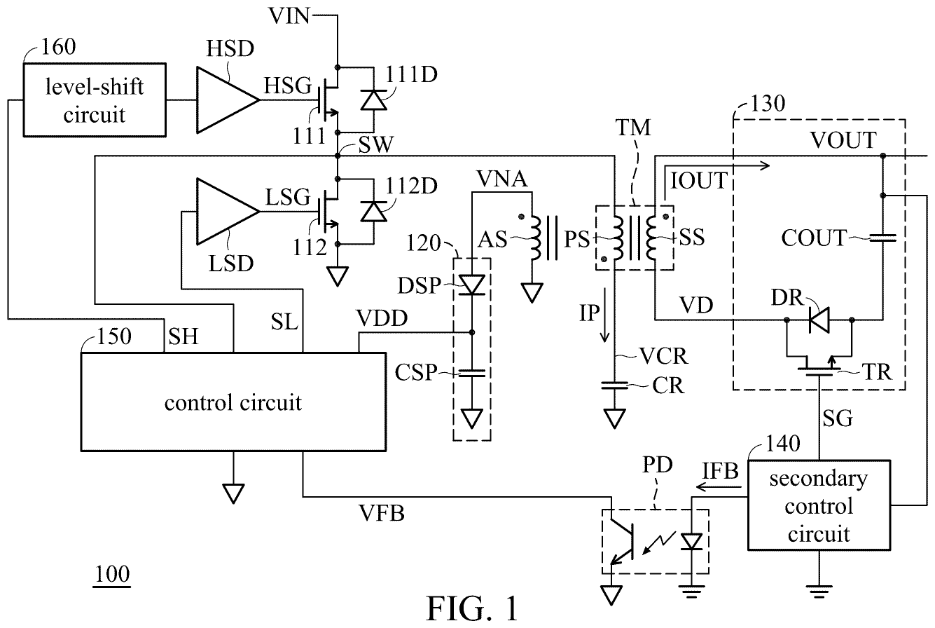

FIG. 1 is a block diagram of a power conversion circuit in accordance with an embodiment of the present invention. As shown in FIG. 1, the power conversion circuit 100 includes a high-side transistor 111, a low-side transistor 112, a resonant capacitor CR, a transformer TM, a voltage generation circuit 120, a rectification circuit 130, a secondary control circuit 140, an opto-coupler PD, a control circuit 150, a level-shift circuit 160, a high-side driving circuit HSD, and a low-side driving circuit LSD.

The high-side transistor 111 provides an input voltage VIN to a switch node SW based on a high-side gate driving signal HSG. According to an embodiment of the present invention, the high-side transistor 111 includes a high-side parasitic diode 111D, where the high-side parasitic diode 111D is coupled between the switch node SW and the input voltage VIN. The low-side transistor 112 couples the switch node SW to the ground based on the low-side gate driving signal LSG. According to an embodiment of the present invention, the low-side transistor 112 includes a low-side parasitic diode 112D, where the low-side parasitic diode 112D is coupled between the switch node SW and the ground.

The resonant capacitor CR is coupled between the resonant node NR and the ground, and a resonant voltage VCR is generated across the resonant capacitor CR. The transformer TM includes a primary coil PS, a secondary coil SS, and an auxiliary coil AS. The primary coil PS is coupled between the switch node SW and the resonant node NR. The auxiliary coil AS is coupled between the auxiliary node NA and the ground, and an auxiliary coil voltage VNA is generated at the auxiliary node NA. The output current IOUT generated by the secondary coil SS generates an output voltage VOUT through the rectification circuit 130.

According to some embodiments of the present invention, the primary coil PS and the resonant capacitor CR are connected in series between the switch node SW and the ground. In other words, the resonant capacitor CR may be coupled between the switch node SW and the resonant node NR, and the primary coil PS may be coupled between the resonant node NR and the ground.

The voltage generation circuit 120 is configured to generate a supply voltage VDD using the auxiliary coil voltage VNA, where the voltage generation circuit 120 includes a supply diode DSP and a supply capacitor CSP. The supply diode DSP is configured to charge the supply capacitor CSP unidirectionally using the auxiliary coil voltage VNA to generate the supply voltage VDD, so as to prevent the supply voltage VDD from affecting the operation of the transformer TM. According to an embodiment of the present invention, when the auxiliary coil voltage VNA generated by the auxiliary coil AS is less than the supply voltage VDD, the supply capacitor CSP is configured to maintain the supply voltage VDD.

The rectification circuit 130 is configured to convert the output current IOUT generated by the secondary coil SS into an output voltage VOUT, and includes a rectification transistor TR and an output capacitor COUT. According to some embodiments of the present invention, the rectification transistor TR further includes a rectification parasitic diode DR. The rectification transistor TR is turned on based on the gate signal SG, so that the output current IOUT output by the secondary coil SS charges the output capacitor COUT to generate the output voltage VOUT. When the rectification transistor TR is turned off, the voltage from the drain terminal to the source terminal of the rectification transistor TR is the drain voltage VD.

The secondary control circuit 140 generates a feedback current IFB based on the output voltage VOUT, where the feedback current IFB generates a feedback voltage VFB through the opto-coupler PD. The secondary control circuit 140 further generates the gate signal SG for converting the output current IOUT generated by the secondary coil SS into the output voltage VOUT.

The control circuit 150 is powered by the supply voltage VDD and generates a high-side driving signal SH and a low-side driving signal SL based on the feedback voltage VFB. The level-shift circuit 160 is configured to shift the voltage level of the high-side driving signal SH to the input voltage VIN, and the high-side drive circuit HSD generates the high-side gate driving signal HSG based on the shifted signal to drive the high-side transistor 111. The low-side driving circuit LSD generates a low-side gate driving signal LSG based on the low-side driving signal SL to drive the low-side transistor 112.

According to some embodiments of the present invention, the control circuit 150 further generates a high-side driving signal SH and a low-side driving signal SL according to the voltage of the switch node SW, so that both the high-side transistor 111 and the low-side transistor 112 achieve zero-voltage switching (ZVS) to improve the conversion efficiency of the power conversion circuit 100. According to some embodiments of the present invention, the power conversion circuit 100 may be a resonant power conversion circuit. According to some embodiments of the present invention, the power conversion circuit 100 may be a resonant flyback power conversion circuit. According to some embodiments of the present invention, the power conversion circuit 100 may be an asymmetrical half-bridge flyback power conversion circuit.

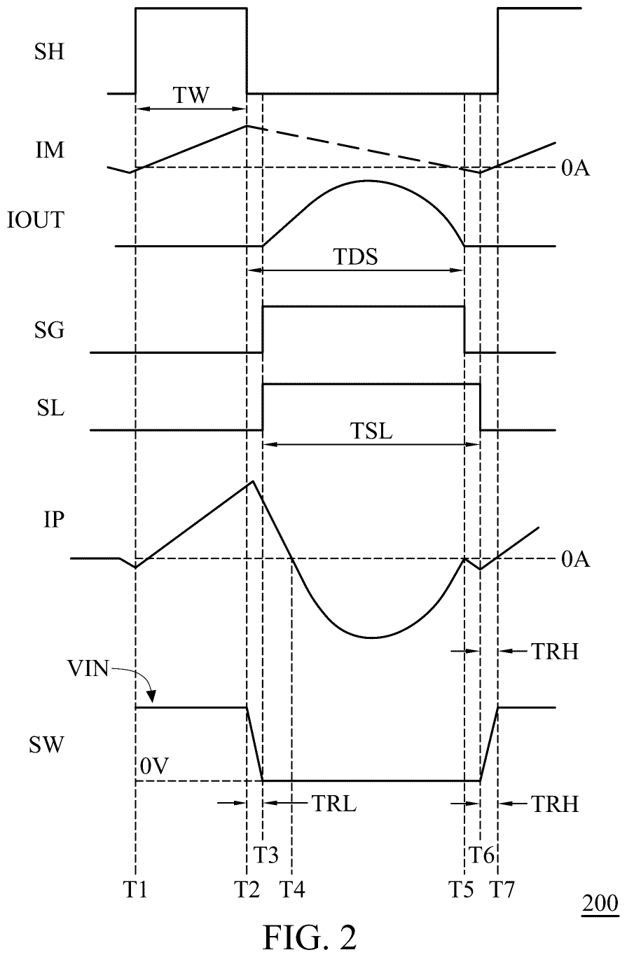

FIG. 2 is a waveform diagram of a power conversion circuit in accordance with an embodiment of the present invention. The following description of the waveform diagram 200 will be described in detail in conjunction with the power conversion circuit 100 of FIG. 1. From the first time point T1 to the second time point T2, the high-side transistor 111 is turned on based on the high-side driving signal SH (i.e., the high-side driving signal SH is at the high logic level). The high-side conduction time TW is the conduction time of the high-side transistor 111. During the high-side conduction time TW, the transformer TM is magnetized to generate a magnetizing current IM. As the conduction time TW increases, the magnetizing current IM of the transformer TM, the primary current IP flowing through the primary coil PS, and the resonant voltage VCR all increase accordingly. In other words, the high-side conduction time TW is the magnetizing time of the transformer TM.

When the high-side transistor 111 is turned off (i.e., the high-side driving signal SH is at the low logic level), the transformer 10 is demagnetizing. During the demagnetization period TDS, the transformer 10 generates an output current IOUT, and the conduction time of the low-side transistor 112 (i.e., the low-side driving signal SL is at the high logic level) corresponds to the demagnetization period TDS. According to some embodiments of the present invention, the low-side conduction time TSL of the low-side driving signal SL is equal to or greater than the demagnetization period TDS. During the demagnetization period TDS, the voltage across the primary coil PS is equal to the resonant voltage VCR, and the output voltage VOUT is as shown in Eq. 1.

$$VCR = n \times VOUT \qquad ( Eq . 1 )$$

$$n = \frac{NP}{NS}$$

NP is the number of turns of the primary coil PS, NS is the number of turns of the secondary coil SS, and the turn ratio n is the number of turns of the primary coil PS divided by the number of turns of the secondary coil SS.

The demagnetization period TDS is shown in Eq. 2.

$$TDS = \frac{( VIN - VCR ) \times TW}{n \times VOUT} \qquad ( Eq . 2 )$$

When the high-side transistor 111 is turned on, (VIN-VCR) is the voltage configured to magnetize the transformer TM.

At the second time point T2, the high-side driving signal SH is converted to the low logic level to turn off the high-side transistor 111. At the third time point T3, the low-side driving signal SL is converted to the high logic level to turn on the low-side transistor 112. According to some embodiments of the present invention, the first dead time TRL from the second time point T2 to the third time point T3 is the dead time from the high-side transistor 111 being turned off to the low-side transistor 112 being turned on.

According to some embodiments of the present invention, during the first dead time TRL, the circulating current generated by the primary coil PS turns on the low-side parasitic diode 112D, and pulls down the voltage of the switch node SW, so that the low-side transistor 112 reaches zero-voltage switching. At the third time point T3, the voltage across the primary coil PS is the resonant voltage VCR of the resonant capacitor CR.

From the third time point T3 to the fourth time point T4, the high-side transistor 111 is turned off, and the low-side transistor 112 is turned on under zero-voltage switching. The rectification transistor TR is turned on, so that the output current IOUT flows through the rectification transistor TR to generate an output voltage VOUT, where the output voltage VOUT is equal to the resonant voltage VCR divided by the turn ratio n, as shown in Eq. 1. In addition, the primary current IP is still positive and flows into the resonant capacitor CR.

According to some embodiments of the present invention, the leakage inductance of the primary coil PS and the resonant capacitor CR form a resonant tank. The output current IOUT is in the form of a sine wave, and the frequency is determined by the resonant frequency of the resonant circuit. The primary current IP is the reflection of the magnetizing current IM plus the output current IOUT.

From the fourth time point T4 to the fifth time point T5, the high-side transistor 111 is continuously turned off and the low-side transistor 112 is continuously turned on. The energy of the transformer TM is continuously transferred to the secondary winding SS, and the energy at this time is provided by the resonant capacitor CR. In addition, since the low-side transistor 112 is continuously turned on, the energy of the resonant capacitor CR is configured to bring the magnetizing current IM to a negative value.

At the fifth time point T5, the rectification transistor TR is not turned on based on the gate signal SG, thereby ending the demagnetization period TDS. From the fifth time point T5 to the sixth time point T6, the resonant capacitor CR continues to reversely magnetize the primary winding PS, so that the primary current IP remains negative until the low-side transistor 112 is turned off.

From the sixth time point T6 to the seventh time point T7, the high-side transistor 111 and the low-side transistor 112 are both turned off, and the primary current IP induced as a negative current from the fifth time point T5 to the sixth time point T6 turns on the high-side parasitic diode 111D, so that the voltage of the switch node SW rises to the input voltage VIN. According to some embodiments of the present invention, the second dead time TRH from the sixth time point T6 to the seventh time point T7 is the dead time from the low-side transistor 112 being turned off to the high-side transistor 111 being turned on.

At the seventh time point T7, the high-side driving signal SH is at the high logic level. Since the voltage of the switch node SW rises to the input voltage VIN, the high-side transistor 111 is able to be turned under zero-voltage switching.

According to some embodiments of the present invention, when the power conversion circuit 100 is started (power-on), since the output voltage VOUT and the resonant voltage VCR are both zero, the primary current IP of negative current is not being generated (as shown from the fifth time point T5 to the seventh time point T7 of FIG. 2), and it is impossible to assist the high-side transistor 111 to achieve zero-voltage switching. In addition, as shown in Eq. 2, the demagnetization period TDS would be very long, which may easily cause the high-side transistor 111 to undergo hard switching, thereby generating a voltage spike at the switch node SW. The voltage spike may generate noise and reduce the reliability of the device. According to some embodiments of the present invention, the startup of the power conversion circuit 100 may also be regarded as the input voltage VIN being provided to the power conversion circuit 100.

For example, when the power conversion circuit 100 starts up and the high-side transistor 111 is turned on, a voltage spike will be generated at the switch node SW. Since the resonant voltage VCR of the resonant capacitor CR is equal to zero, the voltage at the switch node SW is transmitted to the secondary winding SS via the transformer TM. In addition, since the rectification transistor TR is not turned on when the high-side transistor 111 is turned on, the energy of the secondary winding SS has nowhere to be vented, causing the drain voltage VD to increase, and even burning the rectification transistor TR.

In order to avoid the switch node SW generating surges and causing noise, to protect the rectification transistor TR, and to improve the conversion efficiency of the power conversion circuit 100, it is necessary to optimize the power conversion circuit 100.

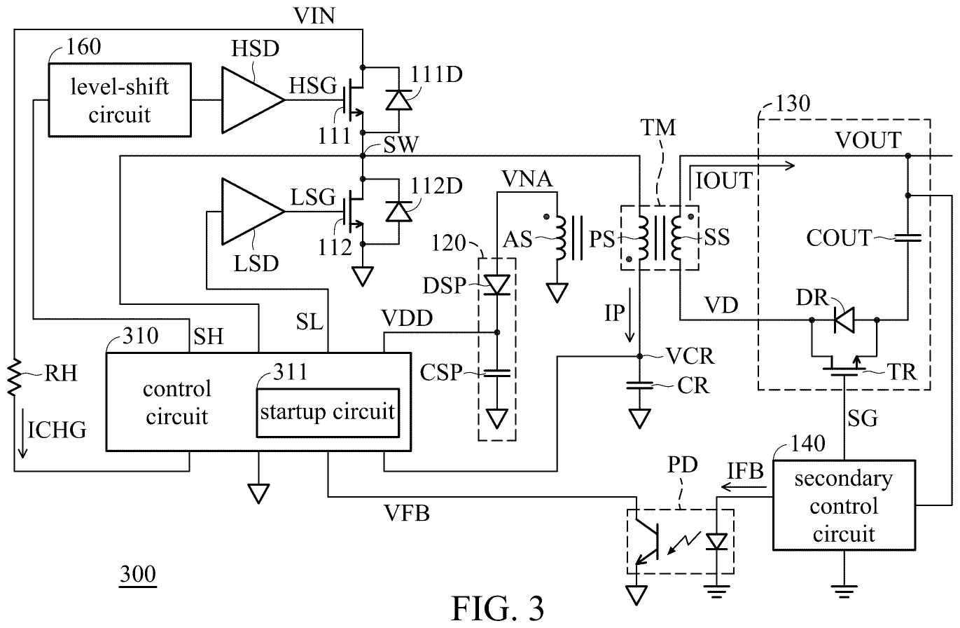

FIG. 3 is a block diagram of a power conversion circuit in accordance with another embodiment of the present invention. Compared with the power conversion circuit 100 of FIG. 1, the power conversion circuit 300 of FIG. 3 further includes a charging resistor RH, and the control circuit 310 of the power conversion circuit 300 further includes a startup circuit 311. When the power conversion circuit 300 starts up, the control circuit 310 uses the charging resistor RH to generate a charging current ICHG from the input voltage VIN, and the startup circuit 311 uses the charging current ICHG to precharge the resonant capacitor CR and generate a supply voltage VDD.

According to some embodiments of the present invention, when the power conversion circuit 300 starts up, the startup circuit 311 first precharges the resonant capacitor CR, and the control circuit 310 then drives the high-side transistor 111 and the low-side transistor 112. According to some embodiments of the present invention, after the startup circuit 311 precharges the resonant capacitor CR, the control circuit 310 first turns on the low-side transistor 112 and then turns on the high-side transistor 111, so that the high-side transistor 111 can be switched at zero voltage to stabilize the voltage of the switch node SW, thereby protecting the rectification transistor TR from burning.

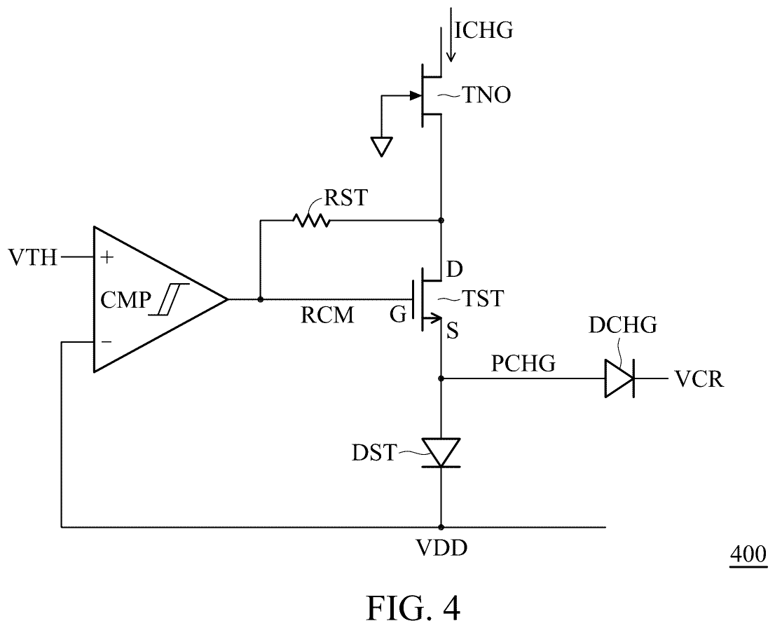

FIG. 4 is a block diagram of a startup circuit in accordance with an embodiment of the present invention. As shown in FIG. 4, the startup circuit 400 includes a normally-on transistor TNO, a startup transistor TST, a startup resistor RST, a startup diode DST, a charging diode DCHG, and a comparator CMP.

The gate terminal of the normally-on transistor TNO is coupled to the ground and receives the charging current ICHG generated by the charging resistor RH in FIG. 3. According to an embodiment of the present invention, the charging resistor RH can step down the input voltage VIN and then provide it to the startup circuit 400. The startup transistor TST includes a gate terminal G, a drain terminal D, and a source terminal S, where the startup resistor RST is coupled to the gate terminal G and the drain terminal D, and the source terminal S generates a precharge signal PCHG. The startup diode DST is coupled between the precharge signal PCHG and the supply voltage VDD in FIG. 3, and the charging diode DCHG is coupled between the precharge signal PCHG and the resonant voltage VCR.

According to some embodiments of the present invention, the startup diode DST is configured to unidirectionally provide the precharge signal PCHG to the supply voltage VDD, and the charging diode DCHG is configured to unidirectionally provide the precharge signal PCHG to the resonant voltage VCR, while the supply voltage VDD and the resonant voltage VCR cannot be reversely provided to the precharge signal PCHG. The comparator CMP is configured to compare the supply voltage VDD and the threshold voltage VTH, and provides the comparison result RCM to the gate terminal G. According to some embodiments of the present invention, when the supply voltage VDD exceeds the threshold voltage VTH, the comparator CMP turns off the startup transistor TST, and stops generating the precharge signal PCHG.

According to some embodiments of the present invention, when the comparator CMP turns off the startup transistor TST, the output terminal of the comparator CMP couples the gate terminal G of the startup transistor TST to the ground, where the resistance values of the charging resistor RH and the start resistor RST are configured to determine the magnitude of the charging current ICHG flowing to the ground. According to some embodiments of the present invention, when the input voltage VIN is provided to the power conversion circuit 300, that is, when the power conversion circuit 300 starts up, the comparator CMP floats the gate terminal G of the startup transistor TST, and the input voltage VIN is provided to the gate terminal G through the charging resistor RH, the normally-on transistor TNO and the startup resistor RST, thereby turning on the startup transistor TST.

According to some embodiments of the present invention, when the input voltage VIN is provided to the power conversion circuit 300 of FIG. 3 to start up the power conversion circuit 300, the startup circuit 311 uses the charging current ICHG to precharge the resonant capacitor CR through the charging diode DCHG to generate the resonant voltage VCR.

In addition, the charging current ICHG simultaneously charges the supply capacitor CSP of FIG. 3 through the startup diode DST to generate the supply voltage VDD, where the supply voltage VDD is configured to power the control circuit 310. In other words, when the power conversion circuit 300 starts up, the startup circuit 400 generates the supply voltage VDD to power the control circuit 310. According to some embodiments of the present invention, the supply voltage VDD may power the comparator CMP.

According to other embodiments of the present invention, when the supply voltage VDD exceeds the threshold voltage VTH, the comparison result RCM generated by the comparator CMP is configured to turn off the startup transistor TST, indicating that the power conversion circuit 300 has completed startup. The control circuit 310 further drives the high-side transistor 111 and the low-side transistor 112 based on the comparison result RCM. When the startup transistor TST is turned off, the startup circuit 400 stops generating the precharge signal PCHG and also stops generating the supply voltage VDD at the same time.

In addition, when the startup circuit 400 stops generating the precharge signal PCHG, the control circuit 310 drives the high-side transistor 111 and the low-side transistor 112 based on the comparison result RCM, so that the auxiliary coil AS generates the supply voltage VDD and continues to power the control circuit 310. According to an embodiment of the present invention, when the power conversion circuit 300 starts up, since the supply voltage VDD is positively correlated with the resonant voltage VCR, determining whether the supply voltage VDD exceeds the threshold voltage VTH is equivalent to determining whether the resonant voltage VCR exceeds the target voltage. In other words, when the supply voltage VDD exceeds the threshold voltage VTH, it means that the resonant voltage VCR exceeds the target voltage, so the control circuit 310 can end the startup process based on the comparison result RCM and start driving the high-side transistor 111 and the low-side transistor 112.

According to some embodiments of the present invention, after the power conversion circuit 300 completes the startup process, the low-side transistor 112 is turned on first and then the high-side transistor 111 is turned on, thereby generating a negative current of the primary current IP illustrated from the fifth time point T5 to the seventh time point T7 of FIG. 2, which helps the high-side transistor 111 to achieve zero-voltage switching.

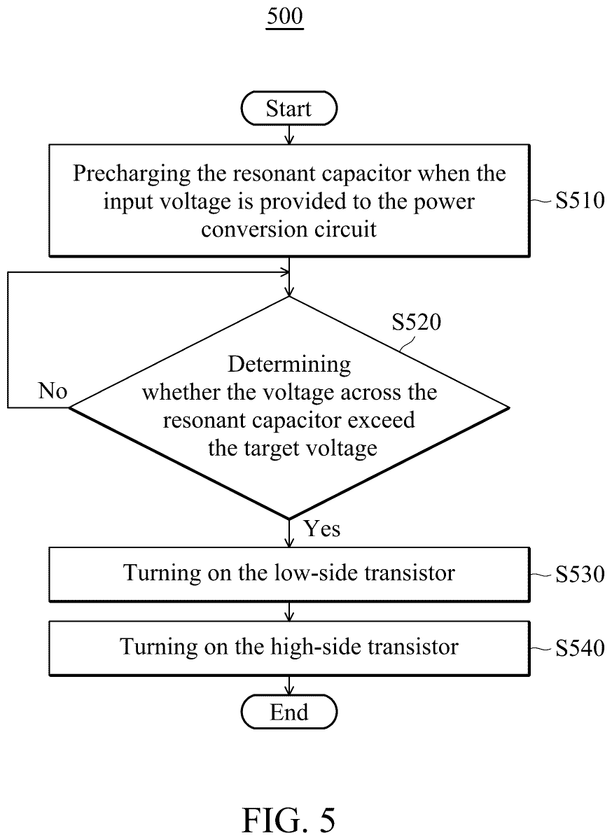

FIG. 5 is a flow chart of a control method in accordance with an embodiment of the present invention. The following description of the control method 500 will be combined with the power conversion circuit 300 of FIG. 3 and the startup circuit 400 of FIG. 4 for detailed description.

First, when the input voltage VIN is provided to the power conversion circuit 300 (that is, the power conversion circuit 300 starts up), the startup circuit 311 of FIG. 3 and the startup circuit 400 of FIG. 4 are configured to precharge the resonant capacitor CR (Step S510). Next, it is determined whether the voltage across the resonant capacitor CR (i.e., the resonant voltage VCR) exceeds the target voltage (Step S520).

According to some embodiments of the present invention, as shown in FIG. 4, since the precharge signal PCHG generates the resonant voltage VCR and the supply voltage VDD via the charging diode DCHG and the start diode DST respectively, the supply voltage VDD is positively correlated with the resonant voltage VCR. In other words, the comparator CMP determines whether the supply voltage VDD exceeds the threshold voltage VTH is equivalent to the comparator CMP determining whether the resonant voltage VCR exceeds the target voltage.

When the determination of Step S520 is yes, it means that the power conversion circuit 300 completes the startup process, and the control circuit 310 first turns on the low-side transistor 112 (Step S530), and then turns on the high-side transistor 111 (Step S540), which helps the high-side transistor 111 to achieve zero-voltage switching and to stabilize the voltage of the switch node SW, thereby reducing noise and improving the reliability of the rectification transistor TR.

According to some embodiments of the present invention, in Step S510 and Step S520, the supply voltage VDD for powering the control circuit 310 is generated by the startup circuit 400 of FIG. 4. In Step S530 and Step S540, the supply voltage VDD for powering the control circuit 310 is generated by charging the supply capacitor CSP through the auxiliary coil AS of FIG. 3 via the supply diode DSP.

The present invention proposes a power conversion circuit and a control method thereof. When a power conversion circuit starts up, the voltage surge of the switch node is reduced by precharging the resonant capacitor during the startup process. After the startup process is complete, turning on the low-side transistor first and then turning on the high-side transistor helps the high-side transistor achieve zero-voltage switching, to further stabilize the voltage of the switch node, thereby reducing noise, improving the reliability of circuit elements, and improving the conversion efficiency of the power conversion circuit.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a transformer, comprising a primary coil and a secondary coil, wherein the primary coil is coupled between a switch node and a resonant node;
a resonant capacitor, coupled between the resonant node and a ground;
a high-side transistor, providing an input voltage to the switch node based on a high-side driving signal;
a low-side transistor, coupling the switch node to the ground based on a low-side driving signal; and
a control circuit, generating the high-side driving signal and the low-side driving signal;
wherein when the power conversion circuit starts up, the control circuit generates a precharge signal to precharge the resonant capacitor.

2. The power conversion circuit as claimed in claim 1, wherein the control circuit further comprises a charging diode;
wherein the precharge signal precharges the resonant capacitor through the charge diode.

3. The power conversion circuit as claimed in claim 1, wherein the power conversion circuit is configured to convert the input voltage into an output voltage.

4. The power conversion circuit as claimed in claim 3, further comprising:
a rectification circuit, configured to convert energy of the secondary coil to the output voltage.

5. The power conversion circuit as claimed in claim 1, wherein the control circuit generates a charging current from the input voltage;
wherein the control circuit uses the charging current to generate a supply voltage powering the control circuit;
wherein the control circuit uses the charging current to generate the precharge signal precharging the resonant capacitor.

6. The power conversion circuit as claimed in claim 5, wherein when the supply voltage exceeds a threshold voltage, the control circuit stops generating the precharge signal;
wherein when the precharge signal is not being generated, the control circuit generates the high-side driving signal and the low-side driving signal.

7. The power conversion circuit as claimed in claim 6, wherein when the precharge signal is not being generated, the control circuit turns on the low-side transistor first and then turns on the high-side transistor, helping the high-side transistor to achieve zero-voltage switching.

8. The power conversion circuit as claimed in claim 1, further comprising:
a charging resistor, coupled to the input voltage and generating a charging current;
wherein the control circuit comprises:
a startup circuit, configured to generate the precharge signal.

9. The power conversion circuit as claimed in claim 8, wherein the startup circuit comprises:
a normally-on transistor, receiving the precharge current;
a startup transistor, comprising a gate terminal, a drain terminal, and a source terminal, wherein the drain terminal is coupled to the normally-on transistor, wherein the source terminal generates the precharge signal;
a startup resistor, coupled between the gate terminal and the drain terminal; and
a startup diode, comprising an anode and a cathode, wherein the anode is coupled to the source terminal, and the cathode generates a supply voltage;
wherein the control circuit is powered by the supply voltage.

10. The power conversion circuit as claimed in claim 8, wherein the startup circuit further comprises:
a comparator, comparing the supply voltage with a threshold voltage to generate a comparison signal;
wherein the comparison signal is provided to the gate terminal;
wherein when the supply voltage exceeds the threshold, the comparator turns off the startup transistor to stop generating the charging current and the precharge signal.

11. The power conversion circuit as claimed in claim 10, wherein the transformer further comprises:
an auxiliary coil, generating an auxiliary coil voltage;
a supply capacitor, configured to maintain the supply voltage; and
a supply diode, configured to use the auxiliary coil voltage to unidirectionally charge the supply capacitor to generate the supply voltage, so as to prevent the supply voltage from affecting operation of the transformer;
wherein when the startup transistor is turned off, the auxiliary coil generates the supply voltage to charge the control circuit.

12. The power conversion circuit as claimed in claim 11, wherein when the auxiliary coil generates the supply voltage, the startup diode is configured to isolate the supply voltage from the source terminal, so as to prevent the supply voltage from affecting the precharge signal.

13. The power conversion circuit as claimed in claim 1, wherein the power conversion circuit is a resonant flyback power conversion circuit.

14. A control method for controlling a power conversion circuit, wherein the power conversion circuit comprises a resonant capacitor coupled between a resonant node and a ground, a transformer comprising a primary coil and a secondary coil, a high-side transistor providing an input voltage to a switch node, and a low-side transistor coupling the switch node to the ground, wherein the primary coil is coupled between the switch node and the resonant node, wherein the control method comprises:
precharging the resonant capacitor when the input voltage is provided to the power conversion circuit;
determining whether a voltage across the resonant capacitor exceeds a target voltage; and
driving the high-side transistor and the low-side transistor when the voltage across the resonant capacitor exceeds the target voltage.

15. The control method as claimed in claim 14, wherein the step of precharging the resonant capacitor when the input voltage is provided to the power conversion circuit further comprises:
generating a charging current from the input voltage;
precharging the resonant capacitor using the charging current; and
generating a supply voltage using the charging current.

16. The control method as claimed in claim 15, wherein the power conversion circuit further comprises a control circuit;
wherein the control circuit is configured to execute the control method;
wherein the control circuit is powered by the supply voltage.

17. The control method as claimed in claim 15, wherein the step of determining whether the voltage across the resonant capacitor exceeds the target voltage further comprises:
determining whether the supply voltage exceeds a threshold voltage; and
stopping generating the precharge current when the supply voltage exceeds the threshold voltage;
wherein the supply voltage is positively correlated with the voltage across the resonant capacitor.

18. The control method as claimed in claim 17, wherein when stopping precharging the resonant capacitor, using an auxiliary coil of the transformer to generate the supply voltage.

19. The control method as claimed in claim 14, wherein the step of driving the high-side transistor and the low-side transistor when the voltage across the resonant capacitor exceeds the target voltage further comprises:
turning on the low-side transistor when a voltage across the resonant capacitor exceeds the target voltage; and
turning on the high-side transistor after the low-side transistor is turned off.

20. The control method as claimed in claim 19, wherein when the high-side transistor is turned on after the low-side transistor is turned off, a current flowing through the primary coil helps the high-side transistor to achieve zero-voltage switching, thereby improving conversion efficiency of the power conversion circuit and stability of a voltage of the switch node.
